(19) United States
(12) Patent Application Publication
(10) Pub. No.: US 2011/0012813 A1
(43) Pub. Date: Jan. 20, 2011

(54) PRESENTATION DEVICE

(76) Inventor: Yasushi Suda, Kasugai (JP)

Correspondence Address: OSTROLENK FABER GERB & SOFFEN, 1180 AVENUE OF THE AMERICAS, NEW YORK, NY, 100368403, US

(21) Appl. No.: 12/834,946

(22) Filed: Jul. 13, 2010

(30) Foreign Application Priority Data
Jul. 16, 2009 (JP) 2009-167529

(51) Int. Cl. G09G 5/00

(52) U.S. Cl. 345/3.1

(57) ABSTRACT

A presentation device comprises an image capture portion for capturing a subject and generating a raw image; a detection portion adapted to analyze whether the raw image contains a prescribed pointing member, and if the raw image contains the pointing member, to detect the location and direction on the subject to which the pointing member points; an extraction portion adapted to extract from the raw image an enlargement target area of prescribed size that lies in an area extraction direction determined according to the detected direction from the detected location; an enlarged image generation portion adapted to enlarge the enlargement target area so as to generate an enlarged image; and an output portion for outputting the enlarged image.

### CROSS-REFERENCE TO RELATED APPLICATION

The present application claims the priority based on Japanese Patent Application No. 2009-167529 filed on Jul. 16, 2009, the disclosure of which is hereby incorporated by reference in its entirety.

### BACKGROUND

1. Technical Field

The present invention relates to a presentation device adapted to capture and generate an image of a document, and display the image on an external display device.

2. Related Art

Most presentation devices have a zoom function for enlarged display of a captured image. Apropos of such zoom functions, the presentation devices disclosed in JP-A-2009-17504 and JP-A-2002-330315 are equipped with a function whereby pointing to an arbitrary location on the document with a laser pointer brings up an enlarged image centered on the specified location. However, with the technology disclosed in these patent literatures, an area of high brightness resulting from the light of the laser pointer being directed thereon is displayed at the center of the enlarged image, which in some instances may reduce the visibility of a substantial part of the enlarged document.

Another presentation device disclosed in JP-A-2002-300432 has a function whereby the location of a color marker positioned resting on the document is detected, and a rectangular area having the color marker at is upper left corner is enlarged and displayed. With this device, during enlarged display of the rectangular area, the magnification is adjusted so that the color marker itself does not appear in the image. However, with the technology disclosed in this patent literature, because the center location of the enlarged display (i.e. the center location of the rectangular area) is coincident with the center of the field of the camera, enlarged display was not possible at every location in the document.

### SUMMARY

An object of the invention is to provide a presentation device that is able to afford more convenient and smooth zoom operation.

A first aspect of the invention is directed to a presentation device. The device includes an image capture portion for capturing a subject and generating a raw image; a detection portion adapted to analyze whether the raw image contains a prescribed pointing member, and if the raw image contains the pointing member, to detect the location and direction on the subject to which the pointing member points; an extraction portion adapted to extract from the raw image an enlargement target area of prescribed size that lies in an area extraction direction determined according to the detected direction from the detected location; an enlarged image generation portion adapted to enlarge the enlargement target area so as to generate an enlarged image; and an output portion for outputting the enlarged image.

According to this aspect, from the location pointed to by the pointer member, there is generated an enlarged display of the enlargement target area that lies in the area extraction direction determined according to the pointing direction of the pointer member. It is accordingly possible to generate the enlarged display at any location on the subject, as well as to vary the location of the area for enlarged display (the enlargement target area) according to the pointing direction of the pointer member. It is possible to carry out a more convenient and smooth zoom operation as a result.

A second aspect of the invention is the presentation device according to the above aspect, wherein where the horizontal direction of the raw image is designated as the X axis direction and the vertical direction of the raw image is designated as the Y axis direction, the detection portion, if the Y component of the detected direction is positive, determines the area extraction direction to be a plus Y direction, or if the Y component of the detected direction is negative, determines the area extraction direction to be a minus Y direction.

According to this aspect, if for example the pointer member points towards a location on the subject from the lower side of the subject, an enlarged display of an area to the upper side of the pointer member is generated; or if it points to a location from the upper side of the subject, an enlarged display of an area to the lower side of the pointer member is generated. It is thus possible to avoid situations in which a substantial part of a subject intended for enlarged display is obscured by the pointer member.

A third aspect of the invention is the presentation device according to the above aspect, wherein the extraction portion performs the extraction such that at least part of the edge of the pointing member contained in the raw image is included at the peripheral border of the enlargement target area.

According to this aspect, the edge of the pointer member is at least partially displayed in the peripheral edge portion of the enlarged display image. It is accordingly possible to readily ascertain that the currently displayed image is an enlarged display image.

A fourth aspect of the invention is the presentation device according to the above aspect, wherein if the enlargement target area being extracted from the raw image at least partially exceeds the range of the raw image, the extraction portion changes the location of the enlargement target area to a location in contact with the inner side of the raw image.

According to this aspect, it is possible for an enlarged image to be displayed in full screen mode, even if the pointer member is pointing towards the edge of subject.

A fifth aspect of the invention is the presentation device according to the above aspect, wherein if the detection portion did not detect the pointing member in the raw image, the output portion outputs the raw image in place of the enlarged image.

According to this aspect, if the pointer member is not pointing to a location on the subject, the captured image continues to be displayed instead of an enlarged image. In other words, it is possible to switch the screen display mode from normal display mode to enlarged display mode simply by pointing to a location on the subject with the pointer member. It is accordingly possible to readily produce an enlarged display of any location on the subject without having to operate a control button or the like.

A sixth aspect of the invention is the presentation device according to the above aspect, wherein if the raw image contains the pointing member, the detection portion detects the magnification ratio indicated by the pointing member, in addition to the location and the direction, the extraction portion changes the size of the enlargement target area according to the magnification ratio.

According to this aspect, it is possible to easily specify a magnification ratio using pointer members that indicate different magnification ratios.

A seventh aspect of the invention is the presentation device according to the above aspect, wherein the pointing member is provided on at least the front face and back face of the pointing member with a member for differentiating between different magnification ratios.

According to this aspect, it is possible to specify different magnification ratios by a simple operation of flipping a single pointer member.

In addition to the presentation device aspects described above, other aspects of the invention may include a control method or usage method of a presentation device; a computer program; a recording medium having a computer program recorded thereon, and the like.

These and other objects, features, aspects, and advantages of the invention will become more apparent from the following detailed description of the preferred embodiments with the accompanying drawings.

### BRIEF DESCRIPTION OF THE DRAWINGS

FIG. 1 is an exterior view of a presentation device;

FIG. 2 is a block diagram depicting internal configuration of the presentation device;

FIG. 3 is a flowchart of an enlarged display process;

FIG. 4 is an illustration depicting a pointer included within raw image data;

FIG. 5 is an illustration depicting a method for determining designated location and area extraction direction;

FIG. 6 is an illustration depicting location and range of an enlargement target area in an instance in which the area extraction direction is upward-facing;

FIG. 7 is a drawing depicting an instance in which the pointer points diagonally from the upper side of the document;

FIG. 8 is an illustration depicting location and range of an enlargement target area in an instance in which the area extraction direction is downward-facing;

FIG. 9 is a diagram depicting an example of an enlarged image displayed on a liquid crystal display;

FIG. 10 is an illustration depicting the concept of edge processing;

FIG. 11 is an illustration depicting location and range of an enlargement target area at 5× magnification;

FIG. 12 is an illustration depicting an example of highlighted area display; and

FIG. 13 is an illustration depicting an example of a picture-in-picture area display.

### DESCRIPTION OF THE PREFERRED EMBODIMENTS

The embodiments of the invention are described below in the following order.

A. Presentation device Features:

### B. Enlarged Display Process:

### C. Additional Embodiments:

### D. Modifications:

### A. Presentation Device Features:

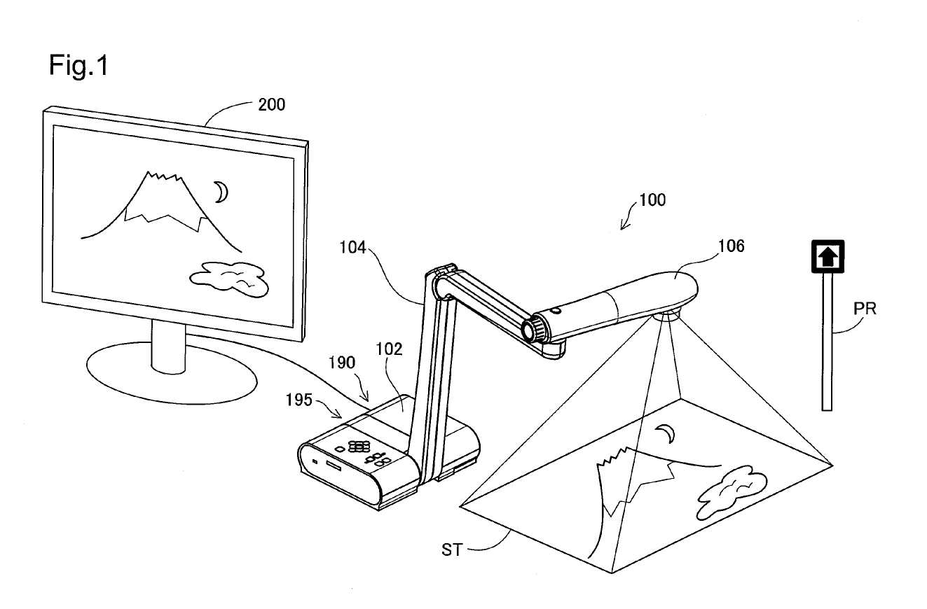

FIG. 1 is an exterior view of a presentation device 100 according to an embodiment of the invention. The presentation device 100 includes a base 102 adapted to be placed on a surface such as a desktop, an articulable support post 104 that extends upward from the base 102, and a camera head 106 mounted on the distal end of the support post 104. The camera head 106 houses a CCD camera, and captures an image of a document ST (subject) that has been positioned on the desktop. A video output terminal 190 and a USB interface 195 are provided on the back face of the base 102. The video output terminal 190 is used to connect a device such as a liquid crystal display 200, a projector, or a television. A computer (not shown) is connected to the USB interface 195. The video output terminal 190 and the USB interface 195 output the image of the document ST captured by the camera head 106.

The presentation device 100 of the present embodiment has a function that, when a pointer member, in this case a pointer PR, points to an arbitrarily selected location on the document ST, generates an enlarged display of an area according to the location and direction that the pointer PR is pointing to. The configuration and process for carrying out this function are described in detail below.

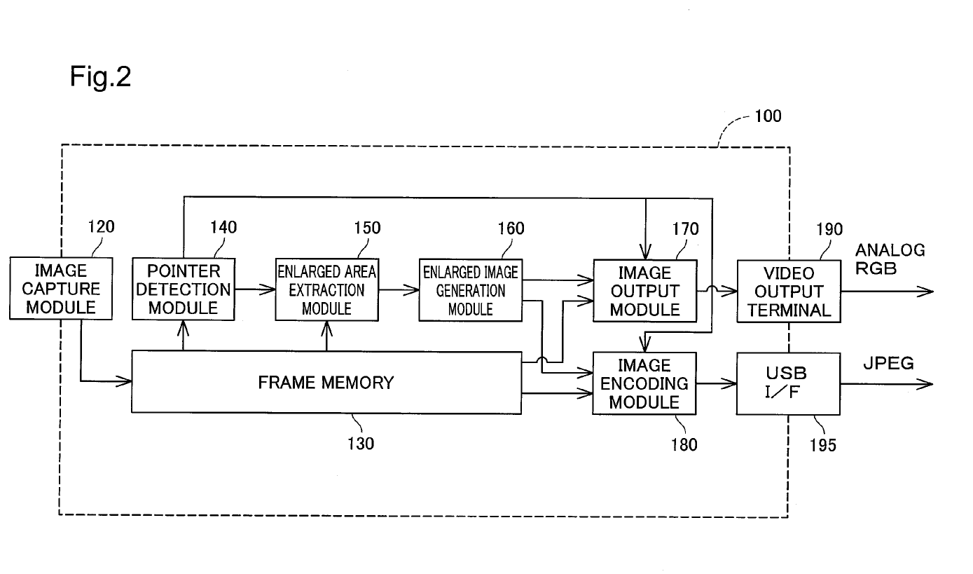

FIG. 2 is a block diagram depicting internal configuration of the presentation device 100. The presentation device 100 includes an image capture module 120, a frame memory 130, a pointer detection module 140, an enlarged area extraction module 150, an enlarged image generation module 160, an image output module 170, and an image encoding module 180. Of these, the pointer detection module 140, the enlarged area extraction module 150, the enlarged image generation module 160, the image output module 170, and the image encoding module 180 are implemented through hardware, using an ASIC (Application Specific Integrated Circuit).

The image capture module 120 is equipped with a CCD camera housed inside the camera head 106, and an analog front end circuit adapted to convert the analog signal output by the CCD camera to a digital signal. The image capture module 120 takes a 15-frame image every second, and sequentially records the images as raw image data in the flash memory 130.

The pointer detection module 140 analyzes the raw image data recorded to the frame memory 130 to determine if it contains an image representing the pointer PR, and if a pointer PR is present, detects the location and direction in which the pointer PR is pointing. According to the direction in which pointer PR is pointing the pointer detection module 140 also determines a direction in which to extract an area for enlarged display. Herein, the location that the pointer PR points to is termed the “designated location”, and the direction in which to extract the area for enlarged display is termed the “area extraction direction”. The method for determining the area extraction direction is described in detail later.

The enlarged area extraction module 150 extracts from the raw image data recorded to the frame memory 130 an area of prescribed size (hereinafter termed the “enlargement target area”) that lies in the area extraction direction from the designated location mentioned above. In the present embodiment, the enlargement target area has size equivalent to one-fourth the size of the raw image data in the horizontal and vertical directions respectively.

The enlarged image generation module 160 enlarges the enlargement target area extracted by the enlarged area extraction module 150 by a predetermined magnification to generate enlarged image data. In the present embodiment, the enlargement target area is enlarged by a factor of 4× in the horizontal and vertical directions respectively. This enlargement process is accomplished through so-called digital zoom.

The image output module 170 carries out D/A conversion and frame rate conversion of the raw image data recorded to the frame memory 130 or the enlarged image data that was generated by the enlarged image generation module 160, and outputs the data from the video output terminal 190 in the form of an RGB signal. The image output module 170 selects the image data for output according to whether the pointer detection module 140 detected the pointer PR in the raw image data. Specifically, if the pointer PR was detected in the raw image data, it outputs the enlarged image data, or if the pointer PR was not detected, it outputs the raw image data.

The image encoding module 180 encodes into JPEG format the raw image data that was recorded to the frame memory 130 or the enlarged image data that was generated by the enlarged image generation module 160, and outputs the JPEG data from the USB interface 195. Like the image output module 170, the image encoding module 180 selects the image data for output according to whether the pointer detection module 140 detected the pointer PR in the raw image data. The image encoding module 180 performs JPEG encoding and outputs JPEG data only when a computer is connected to the USB interface 195.

### B. Enlarged Display Process:

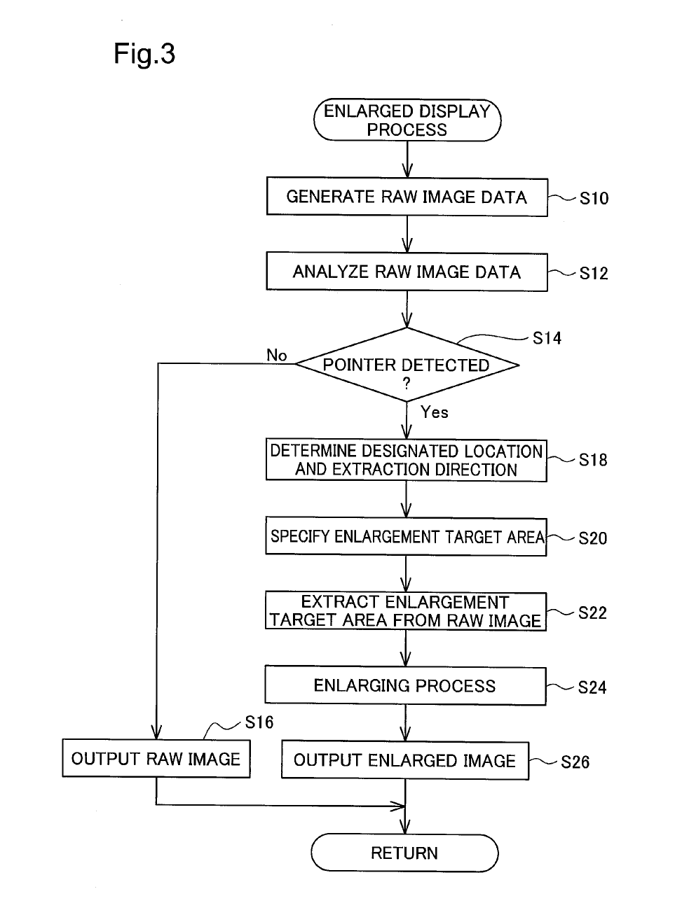

FIG. 3 is a flowchart of an enlarged display process executed cooperatively by the blocks shown in FIG. 2. This enlarged display process is executed repeatedly during the time that the presentation device 100 is powered on. When the enlarged display process is executed, the image capture module 120 captures an image of the document ST, generates raw image data, and records it to the frame memory (Step S10).

Once the raw image data is recorded to the flash memory 130, the pointer detection module 140 analyzes the data (Step S12) and decides whether an image representing the pointer PR is detected in the raw image data (Step S14).

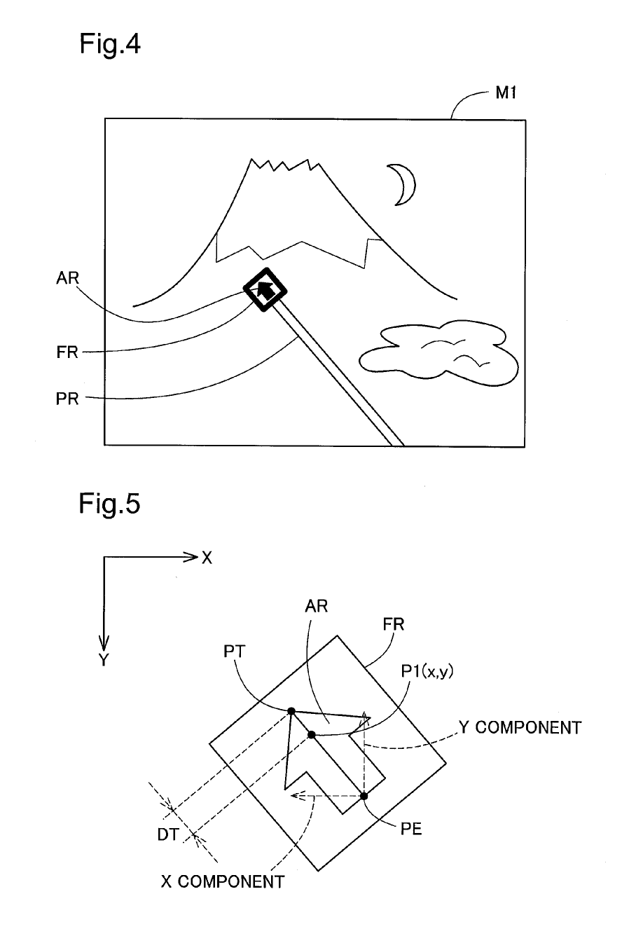

FIG. 4 is an illustration depicting a pointer PR included within raw image data M1. In the present embodiment, the distal end of the pointer PR is provided with a member having a design in which an arrow AR is situated within a rectangular frame FR. Thus, the pointer detection module 140 first detects the rectangular frame FR in the raw image data M1, using a known pattern matching method. If the rectangular frame FR is detected in the raw image data M1, the pointer detection module 140 decides that the pointer PR was detected in the raw image data M1. If on the other hand the rectangular frame FR is not detected in the raw image data M1, the pointer detection module 140 decides that the pointer PR was not detected in the raw image data M1.

If decided in Step S14 that the pointer PR was detected in the raw image data M1, the pointer detection module 140 determines the designated location and the area extraction direction (Step S18).

FIG. 5 is an illustration depicting a method for determining designated location and area extraction direction. In FIG. 5, the rectangular frame FR and the arrow AR shown in FIG. 4 are represented in simplified fashion. In the preceding Step S18, using a known pattern matching method the pointer detection module 140 first detects the arrow AR situated inside the frame FR. It then determines a designated location having a prescribed positional relationship relative to the arrow AR. As a specific example, a location situated a prescribed distance DT (e.g. a distance equivalent to about 3 mm) towards the back end PE from the tip PT of the arrow AR is determined to be the designated location P1 (x, y). Then, where the upper left corner of the raw image data M1 is designated the origin (0, 0), the horizontal direction of the raw image data M1 is the X direction, and the vertical direction is the Y direction, the pointer detection module 140 calculates a Y component direction of the direction in which the arrow is facing. As illustrated in FIG. 5, if the Y component direction is a negative direction, the area extraction direction is determined to be an upward-facing direction (−Y direction). Conversely, if the Y component direction is a positive direction, the area extraction direction is determined to be a downward-facing direction (+Y direction). That is, in the present embodiment, if the pointer PR is determined to point to any direction towards the upper side of the document ST, the area extraction direction is determined to be an upward-facing direction, whereas if the pointer PR is determined to point to any direction towards the lower side of the document ST, the area extraction direction is determined to be a downward-facing direction. If the pointer PR is pointing to the horizontal, the Y component of the arrow AR is zero; in the present embodiment, in such instances the area extraction direction is designated by rule to be an upward facing direction.

As shown in FIG. 3, once the designated location P1 and the area extraction direction are determined in Step S18, the enlarged area extraction module 150 specifies a location and range for the enlargement target area, according to the designated location P1 and the area extraction direction so determined (Step S20).

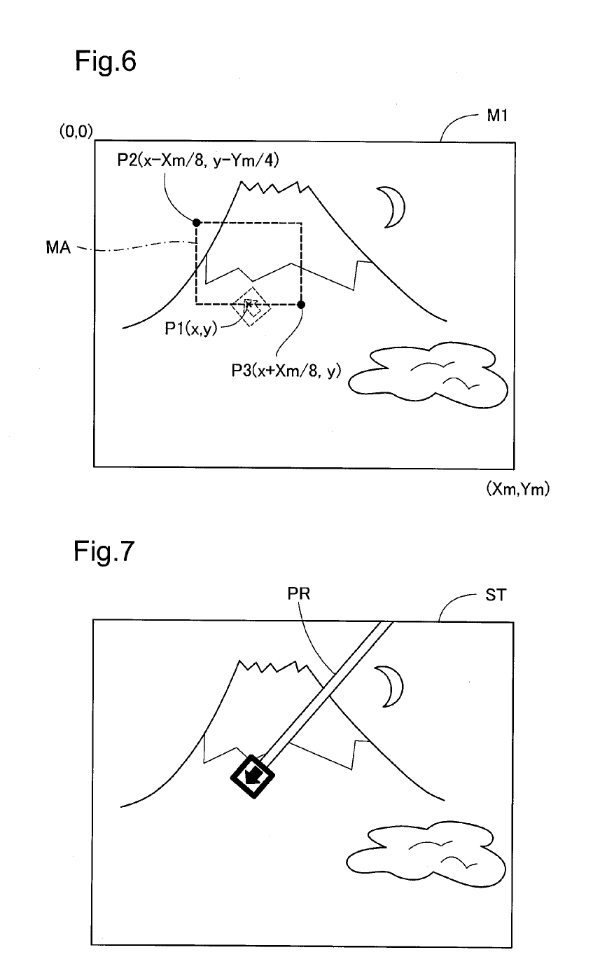

FIG. 6 is an illustration depicting location and range of the enlargement target area MA in an instance in which the area extraction direction is upward-facing. If the area extraction direction is upward-facing, the enlarged area extraction module 150 specifies a enlargement target area MA that is a rectangular area having the designated location P1 as the center point of its bottom side, height equivalent to one-fourth the height Ym of the raw image data, and width equivalent to one-fourth the width Xm of the raw image data. The coordinates P2 of the upper left corner of the enlargement target area MA specified in this way are (x−Xm/8, y−Ym/4), and the coordinates P3 of the lower right corner are (x+Xm/8, y).

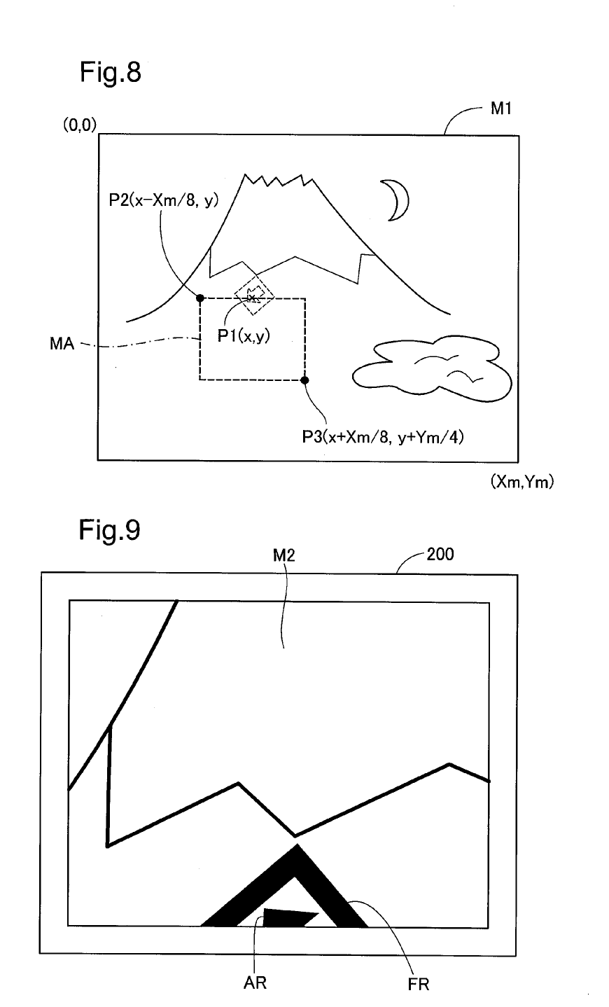

FIG. 7 is a drawing depicting an instance in which the pointer PR points diagonally towards the lower side of the document ST, and FIG. 8 is an illustration depicting the location and range of the enlargement target area MA in this instance. In the present embodiment, if the pointer PR points in any direction towards the lower side of the document ST, the area extraction direction is the downward-facing direction. Accordingly, in such instances the enlarged area extraction module 150 specifies an enlargement target area MA that is a rectangular area having the designated location P1 as the center point of its top side, height equivalent to one-fourth the height Ym of the raw image data, and width equivalent to one-fourth the width Xm of the raw image data. The coordinates P2 of the upper left corner of the enlargement target area MA specified in this way are (x−Xm/8, y), and the coordinates P3 of the lower right corner are (x+Xm/8, y+Ym/4).

As shown in FIG. 3, once the location and range of the enlargement target area MA are determined in Step S20, the enlarged area extraction module 150 extracts the enlargement target area MA from the raw image data recorded in the flash memory (Step S22). In the present embodiment, the designated location P1 pointed to by the pointer PR is a location to the inside of the arrow AR, not the top of the arrow AR or the rectangular frame FR. Thus, the enlargement target area MA extracted in Step S22 includes at least portions of the rectangular frame FR and the arrow AR at the distal end of the pointer PR (see FIGS. 6, 8).

Once the enlargement target area MA is extracted from the raw image data by the enlarged area extraction module 150, the enlarged image generation module 160 enlarges the extracted enlargement target area MA by a magnification ratio of 4× in the vertical and horizontal directions respectively, producing an enlarged image (Step S24). The image output module 170 then outputs the enlarged image generated in this way from the video output terminal 190 (Step S26). At the same time, the image encoding module 180 encodes in JPEG format the enlarged image that was generated by the enlarged image generation module 160, and outputs the data to the USB interface 195.

FIG. 9 is a diagram depicting an example of an enlarged image M2 displayed on the liquid crystal display 200. FIG. 9 depicts the enlarged image M2 in an instance in which the area extraction direction is upward-facing. As noted previously, because the enlargement target area MA includes portions of the rectangular frame FR and the arrow AR at the distal end of the pointer PR, the enlarged image M2 displayed on the liquid crystal display 200 also includes portions of the rectangular frame FR and the arrow AR at the distal end of the pointer PR. Because FIG. 9 depicts an example in which the area extraction direction is upward-facing, the frame FR and the arrow AR are included at the lower edge of the enlarged image M2; however, if the area extraction direction were downward-facing, the frame FR and the arrow AR would be included at the upper edge of the enlarged image M2.

The process of Steps S18 to S26 described above is a process that takes place if it is decided in Step S14 that the pointer PR was detected in the raw image data. If on the other hand it is decided in Step S14 that the pointer PR was not detected in the raw image data, the image output module 170 outputs the raw image data recorded in the frame memory 130 to the video output terminal 190 (Step S16). At the same time, the image encoding module 180 encodes in JPEG format the raw image data recorded in the frame memory 130, and outputs the data to the USB interface 195.

During the time that the presentation device 100 is powered on, the enlarged display process described above is executed repeatedly. Thus, when the pointer PR crosses into the document ST (more specifically, into the field of the camera head 106), the enlarged image M2 is instantaneously displayed on the liquid crystal display 200. Then, as the pointer PR travels across the document ST, the enlargement target area MA moves in association therewith. The enlarged image M2 that is output to the liquid crystal display 200 thus takes the form of a scrolling display that scrolls in association with travel of the pointer PR.

In Step S20 above, if at least a portion of the enlargement target area MA intended to be specified according to the designated location P1 and the area extraction direction that were determined in Step S18 falls outside the boundaries of the raw image data M1, the enlarged area extraction module 150 performs edge processing to change the location of the enlargement target area MA to a location contacting the inner edges of the raw image data M1.

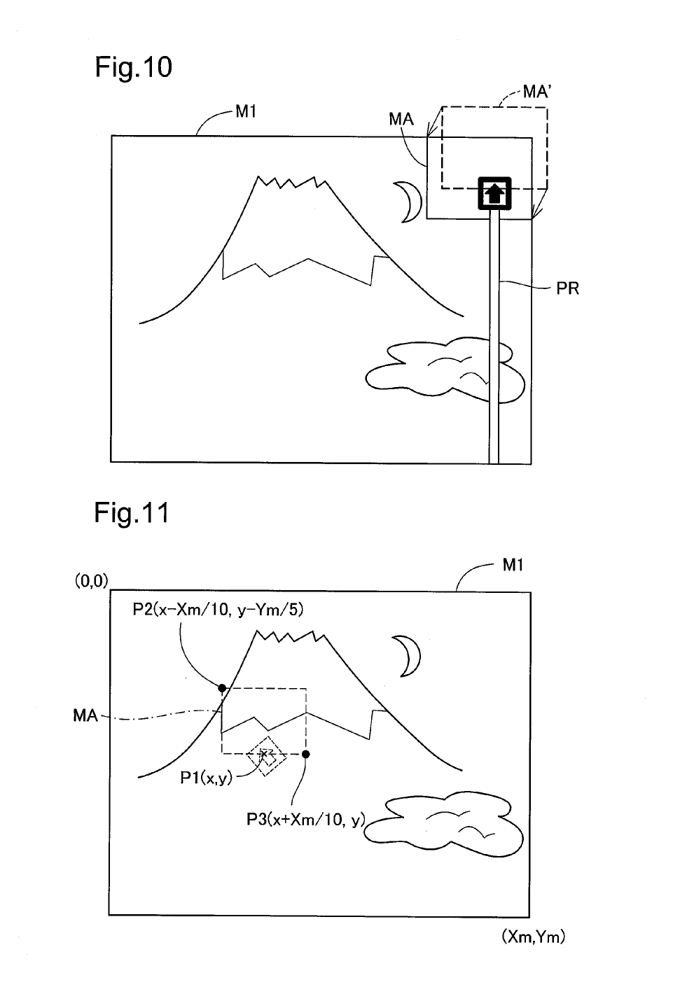

FIG. 10 is an illustration depicting the concept of edge processing. FIG. 10 depicts an instance in which an enlargement target area MA′ intended to be specified according to the designated location of the pointer PR protrudes out beyond the upper right corner of the raw image data Ml. In this instance, the enlarged area extraction module 150 changes the location of the enlargement target area MA to one at the upper right corner of the raw image data M1. Thus, even if the pointer PR is pointing to an edge on the document ST, an enlarged image may be displayed in the entire display area of the liquid crystal display 200.

During this edge processing, if the area extraction direction is upward-facing and if the Y coordinate of the designated location P1 is less than Ym/4, the Y coordinate of the coordinates P2 of the upper left corner of the enlargement target area MA is held to zero. On the other hand, if the area extraction direction is downward-facing and if the Y coordinate of the designated location P1 exceeds Ym-Ym/4, the Y coordinate of the coordinates P2 of the upper left corner of the enlargement target area MA is held to Ym−Ym/4. Regardless of whether the area extraction direction is upward-facing or downward-facing, if the X coordinate of the designated location P1 is less than Xm/8, the X coordinate of the coordinates P2 of the upper left corner of the enlargement target area MA is held to zero. If the X coordinate of the designated location P1 exceeds Xm−Xm/8, the X coordinate of the coordinates P2 of the upper left corner of the enlargement target area MA is held to Xm-Xm/4.

According to the presentation device 100 of the present embodiment described above, once the pointer PR is used to point to any location on the document ST, a enlargement target area MA is displayed enlarged to full screen according to the location and direction being pointed to. At this time, if the pointing direction of the pointer PR is any upward-facing direction, an area lying above the pointer PR is enlarged and displayed, or if it is any downward-facing direction, an area lying below the pointer PR is enlarged and displayed. It is thereby possible to avoid situations in which a substantial part of the enlarged document ST is obscured by the pointer PR.

According to the present embodiment, even if the pointer PR is pointing in a diagonal direction, the area extraction direction is held to either the upward-facing direction or the downward-facing direction, so the enlargement target area MA does not tilt. The displayed enlarged images are thus easily viewed by the audience.

Additionally, according to the present embodiment, portions of the rectangular frame FR and the arrow AR provided at the distal end of the pointer PR are displayed at the upper edge or lower edge of the enlarged image M2, making it possible to readily ascertain whether the currently displayed image is the raw image or an enlarged image.

Further, according to the present embodiment, an enlarged display of the document ST is generated simply by positioning the pointer PR over the document ST. It is accordingly possible to switch the screen display mode from normal display mode to enlarged display mode simply by pointing to a location on the document ST with the pointer PR. Also, as the pointer PR travels over the document ST, the enlargement target area MA moves in association therewith, producing a scrolling display of the enlargement target area MA. It is accordingly possible to carry out smooth, convenient zoom operation without having to operate a control button provided to the base 102 for example.

### C. Additional Embodiments:

(1) In the preceding embodiment the magnification ratio for images was fixed at 4×, but the magnification ratio is not limited thereby. The magnification ratio may be set between 2× and 5× for example. A variable magnification ratio that can be changed through operation of a button provided to the base 102 is also acceptable. FIG. 11 depicts the location and range of the enlargement target area MA at 5× magnification. By setting the magnification ratio to 5×, the size of the enlargement target area MA is smaller than when the magnification ratio is 4×.

(2) A variable magnification ratio may be achieved through other methods as well. For example, by adapting the pointer detection module 140 to recognize different shapes, size, or color of the rectangular frame FR or arrow AR in the member provided at the distal end of the pointer PR, the magnification ratio may be varied according to shape, size, or color. For example, arrows of different size may be provided on the front and back faces of the pointer PR, and the magnification ratio may be switched according to the size of the arrow (e.g. 4× with the front face versus 5× with the back face). Such an arrangement enables the user to easily change the magnification ratio by a simple operation of flipping the pointer PR. Naturally, it is also possible to vary the magnification ratio easily by preparing a number of pointers PR indicating different magnification ratios, and using the pointers PR selectively.

(3) In the preceding embodiment, portions of the rectangular frame FR and the arrow AR of the pointer PR are displayed at the upper edge or lower edge of the enlarged image M2, but these need not be displayed. Specifically, raw image data devoid of the pointer PR and raw image data that includes the pointer PR may be saved separately to the frame memory 130. The designated location and area extraction direction are then determined based on the raw image data that includes the pointer PR, but the enlargement target area MA that is actually displayed in enlarged form is extracted from the raw image data devoid of the pointer PR. It is possible thereby to display an enlarged image devoid of the rectangular frame FR and the arrow AR of the pointer PR. An additional possibility is to extract the enlargement target area MA from a location a sufficient distance away from the designated location, to display an enlarged image devoid of the rectangular frame FR and the arrow AR of the pointer PR, for example.

(4) In the preceding embodiment, the area extraction direction was limited to the two directions of upward-facing and downward-facing, but leftward-facing or rightward-facing directions could also be determined as area extraction directions. Specifically, the magnitude of the X component and the magnitude of the Y component of the direction in which the arrow AR is facing are compared, and if the Y component is greater, the direction is designated as upward-facing or downward-facing, whereas if the X component is greater, the direction is designated as leftward-facing or rightward-facing. If the direction of the X component is a positive direction, the area extraction direction is designated as rightward-facing, and if the direction of the X component is a negative direction, the area extraction direction is designated as leftward-facing.

### D. Modifications:

It is to be understood that while the invention has been shown herein through certain preferred embodiments, there is no intention to limit the invention thereto, and various alternative aspects are possible within the spirit and scope of the invention. Possible modifications include the following, for example.

### Modification 1:

In the preceding embodiment, the location and range of the enlargement target area MA are specified according to the location and direction pointed to by the pointer PR, and an enlarged display of this enlargement target area MA is generated. However it is possible to instead establish an area corresponding to the enlargement target area MA as a highlighted area, with the area outside the highlighted area either not displayed, or displayed with reduced brightness.

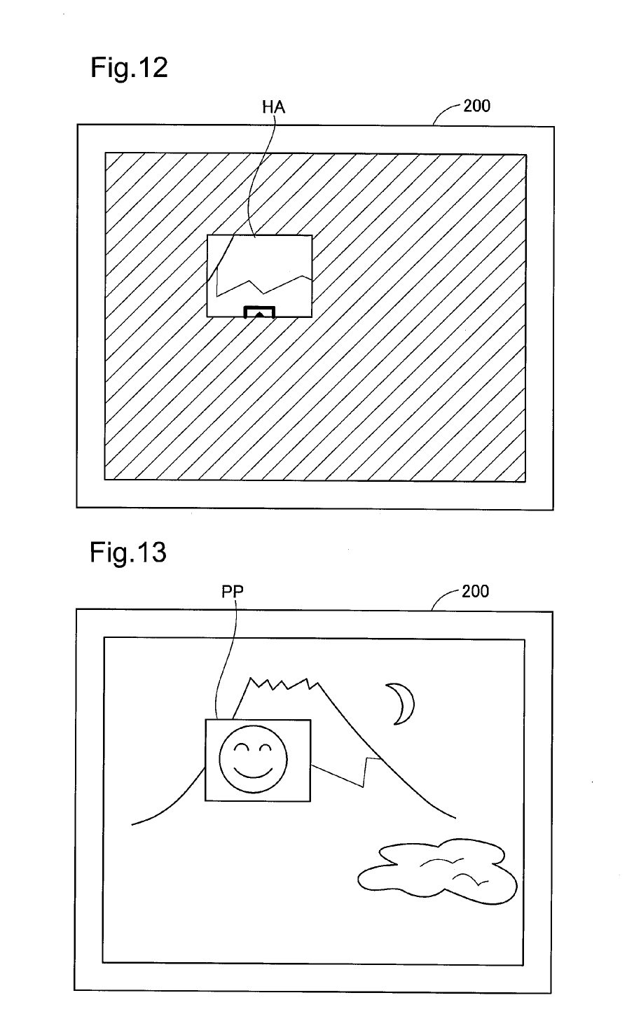

FIG. 12 is an illustration depicting an example of a highlighted area display. As shown in the drawing, in the present modification, only a highlighted area HA is displayed on the liquid crystal display 200, and the remaining area is dimmed. The highlighted area HA moves over the screen in association with movement of the pointer PR. With such a display it is possible to focus the attention of the audience on a particular location on the document ST.

### Modification 2:

In Modification 1, the highlighted area is an area corresponding to the enlargement target area MA, but this area could be a picture-in-picture area as well. A video or still image input from a computer or another video device may be displayed in this picture-in-picture area.

FIG. 13 is an illustration depicting an example of a picture-in-picture area display. As shown in the drawing, in the present modified example, a picture-in-picture area PP is displayed superimposed over the raw image data representing the document ST. The picture-in-picture area PP moves over the screen in association with movement of the pointer PR. With such a display it is possible for a document that is different from (or related to) the document ST, or a video or still image, to be displayed at any location on the document ST.

### Modification 3:

In the preceding embodiment, the enlarged display process depicted in FIG. 3 was carried by the ASIC that constitutes the pointer detection module 140, the enlarged area extraction module 150, the enlarged image generation module 160, the image output module 170, and the image encoding module 180. However, the enlarged display process may be carried out through software by a microcomputer furnished with a CPU, RAM and ROM.

### Modification 4:

In the preceding embodiment, the tip of the pointer PR was provided with a member having a design with an arrow AR positioned inside a rectangular frame FR. However, the design is arbitrary, and other designs are possible provided that location and direction are detectable.

What is claimed is:

1. A presentation device comprising:
an image capture portion for capturing a subject and generating a raw image;
a detection portion adapted to analyze whether the raw image contains a prescribed pointing member, and if the raw image contains the pointing member, to detect the location and direction on the subject to which the pointing member points;
an extraction portion adapted to extract from the raw image an enlargement target area of prescribed size that lies in an area extraction direction determined according to the detected direction from the detected location;
an enlarged image generation portion adapted to enlarge the enlargement target area so as to generate an enlarged image; and
an output portion for outputting the enlarged image.

2. The presentation device according to claim 1, wherein
where the horizontal direction of the raw image is designated as the X axis direction and the vertical direction of the raw image is designated as the Y axis direction,
the detection portion, if the Y component of the detected direction is positive, determines the area extraction direction to be a plus Y direction, or if the Y component of the detected direction is negative, determines the area extraction direction to be a minus Y direction.

3. The presentation device according to claim 1, wherein
the extraction portion performs the extraction such that at least part of the edge of the pointing member contained in the raw image is included at the peripheral border of the enlargement target area.

4. The presentation device according to claim 1, wherein
if the enlargement target area being extracted from the raw image at least partially exceeds the range of the raw image, the extraction portion changes the location of the enlargement target area to a location in contact with the inner side of the raw image.

5. The presentation device according to claim 1, wherein
if the detection portion did not detect the pointing member in the raw image, the output portion outputs the raw image in place of the enlarged image.

6. The presentation device according to claim 1, wherein
if the raw image contains the pointing member, the detection portion detects the magnification ratio indicated by the pointing member, in addition to the location and the direction,
the extraction portion changes the size of the enlargement target area according to the magnification ratio.

7. The presentation device according to claim 6, wherein
the pointing member is provided on at least the front face and back face of the pointing member with a member for differentiating between different magnification ratios.
